(19) United States
(12) Patent Application Publication
(10) Pub. No.: US 2020/0319138 A1
(43) Pub. Date: Oct. 8, 2020

(54) CATALYST DISTRIBUTION FOR OXYGEN SENSOR FABRICATION

(71) Applicant: GM Global Technology Operations LLC, Detroit, MI (US)

(72) Inventors: Misle M. Tessema, Warren, MI (US); Daad B. Haddad, Sterling Heights, MI (US); Ratandeep S. Kukreja, Warren, MI (US)

(21) Appl. No.: 16/374,259

(22) Filed: Apr. 3, 2019

(51) Int. Cl. G01N 27/407; B01D 53/86

(52) U.S. Cl. CPC G01N 27/4076; G01N 27/4077; B01D 2255/1023; B01D 2255/1021; B01D 53/86

(57) ABSTRACT

An oxygen sensor for a motor vehicle includes a substrate and an alumina coating covering the substrate, palladium (Pd) and platinum (Pt) catalyst particles being uniformly distributed in the alumina coating. The substrate includes a first ceramic layer including a Nernst cell, a second ceramic layer including a reference cell, a third ceramic layer, the second ceramic layer positioned between the first ceramic layer and the third ceramic layer, a heater element positioned between the second ceramic layer and the third ceramic layer.

### INTRODUCTION

The present disclosure relates to an oxygen sensor. More specifically, the present disclosure relates to an oxygen sensor with uniform catalyst distribution.

Many motor vehicles are powered by internal combustion engines. These engines typically include an oxygen sensor that measures the oxygen content of the exhaust gases. These measurements are forwarded to, for example, a controller that regulates the air/fuel mixture and exhaust gas emissions of the engine.

During the fabrication of an oxygen sensor, an alumina coating is applied to a substrate and the coating is dipped into a catalyst solution. The sensor is subsequently heated internally to dry the catalyst solution. During the drying process, however, the catalyst particles tend to migrate to the source of heat in the sensor. As such, the distribution of the catalyst particles in the alumina coating is non-uniform. Non-uniform agglomeration of the catalyst particles leads to sintering of the particles during the use of the sensor, resulting in declined catalytic activity and reduced durability of the sensor.

Thus, while current oxygen sensors achieve their intended purpose, there is a need for a new and improved sensor and fabrication process to provide a sensor that eliminates or reduces sintering effects and, hence, promotes improved performance and durability.

### SUMMARY

According to several aspects, an oxygen sensor for a motor vehicle includes a substrate and an alumina coating covering the substrate, palladium (Pd) and platinum (Pt) catalyst particles being uniformly distributed in the alumina coating. The substrate includes a first ceramic layer including a Nernst cell, a second ceramic layer including a reference cell, a third ceramic layer, the second ceramic layer positioned between the first ceramic layer and the third ceramic layer, a heater element positioned between the second ceramic layer and the third ceramic layer.

In an additional aspect of the present disclosure, the Nernst cell is defined by a first electrode and a second electrode spaced apart from the first electrode.

In another aspect of the present disclosure, the first electrode and the second electrode are made of Pt.

In another aspect of the present disclosure, the reference cell is a hollow region in the second ceramic layer to provide a channel for gas flow.

In another aspect of the present disclosure, a catalyst particles or precursor solution is premixed in an alumina slurry that is sprayed onto the substrate to form the alumina coating.

In another aspect of the present disclosure, the catalyst precursor solution is nitrate based including Pd(NO₃)₂ and Pt(NO₃)₄ or chloride based including PdCl₂ and PtCl₂.

In another aspect of the present disclosure, an alumina slurry is sprayed onto the substrate to form the alumina coating which is subsequently dipped into a catalyst precursor solution.

In another aspect of the present disclosure, the catalyst precursor solution is nitrate based including Pd(NO₃)₂ and Pt(NO₃)₄ or chloride based including PdCl₂ and PtCl₂.

In another aspect of the present disclosure, an external heater is activated to dry the alumina slurry with the Pd/Pt precursors.

In another aspect of the present disclosure, the alumina coating fully covers the substrate.

According to several aspects, a method of forming an oxygen sensor implemented in a motor vehicle includes applying an alumina slurry covering a substrate, palladium (Pd) and platinum (Pt) catalyst particles or precursors being uniformly distributed in the alumina slurry, and heating the alumina slurry to form an alumina coating with uniformly distributed Pd and Pt catalyst particles. The substrate includes a first ceramic layer with a Nernst cell, a second ceramic layer with a reference cell, and a third ceramic layer, the second ceramic layer positioned between the first ceramic layer and the third ceramic layer, and a heater element positioned between the second ceramic layer and the third ceramic layer.

In another aspect of the present disclosure, the Nernst cell is defined by a first electrode and a second electrode spaced apart from the first electrode.

In another aspect of the present disclosure, the reference cell is a hollow region in the second ceramic layer to provide a channel for gas flow.

In another aspect of the present disclosure, a catalyst particles or precursor solution is premixed in the alumina slurry that is sprayed onto the substrate to form the alumina coating.

In another aspect of the present disclosure, the catalyst precursor solution is nitrate based including Pd(NO₃)₂ and Pt(NO₃)₄ or chloride based including PdCl₂ and PtCl₂.

In another aspect of the present disclosure, the alumina slurry is sprayed onto the substrate to form the alumina coating which is subsequently dipped into a catalyst precursor solution.

In another aspect of the present disclosure, the catalyst precursor solution is nitrate based including Pd(NO₃)₂ and Pt(NO₃)₄ or chloride based including PdCl₂ and PtCl₂.

In another aspect of the present disclosure, heating includes heating with an external heater that is activated to dry the alumina slurry with the Pd/Pt particles/precursors.

In another aspect of the present disclosure, the alumina coating fully covers the substrate.

According to several aspects, an oxygen sensor for a motor vehicle includes a substrate and an alumina coating covering the substrate, palladium (Pd) and platinum (Pt) catalyst particles being uniformly distributed in the alumina coating. The substrate includes a first ceramic layer including a Nernst cell, the Nernst cell being defined by a first electrode and a second electrode spaced apart from the first electrode, the first electrode and the second electrode being made from Pt; a second ceramic layer including a reference cell, the reference cell being a hollow region in the second ceramic layer to provide a channel for gas flow; a third ceramic layer, the second ceramic layer positioned between the first ceramic layer and the third ceramic layer; and a heater element positioned between the second ceramic layer and the third ceramic layer.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a top view of an oxygen sensor according to an exemplary embodiment;

FIG. 2 is a cross-sectional view of an oxygen sensor;

FIG. 3 is a cross-sectional view of an oxygen sensor according to an exemplary embodiment;

FIG. 4 is a cross-sectional view of an oxygen sensor; and

FIG. 5 is a cross-sectional view of an alternative oxygen sensor and an external heater according to an exemplary embodiment.

### DETAILED DESCRIPTION

The following description is merely exemplary in nature and is not intended to limit the present disclosure, application, or uses.

Referring to FIG. 1, there is shown an oxygen sensor 10 for a motor vehicle in accordance with the principles of the present disclosure. The sensor 10 includes a substrate 17 surrounded by an alumina coating 32 with palladium (Pd) and platinum (Pt) catalyst particles uniformly distributed in the alumina coating 32. The substrate 17, in certain arrangements, includes an extension with contact pads 13 and 15. The contact pads 13 and 15 provide an electrical connection to, for example, a controller that monitors and controls the performance of a combustion engine associated with the motor vehicle.

Referring further to FIG. 3, there is shown a cross-sectional view through the alumina coating 32 and the substrate 17. The substrate 17 includes a first ceramic layer 24, a second ceramic layer 22 and a third ceramic layer 20. The substrate further includes a first electrode 14 and a second electrode 16, defining a Nernst cell. In certain arrangements, the first electrode 14 and the second electrode 16 are made from Pt. In various arrangements, the second ceramic layer 22 has a reference cell 12. The reference cell 12, in particular arrangements, is a hollow region that provides a channel for gas flow through the sensor 10.

During the fabrication of the sensor 10, the Pd and Pt catalyst particles are synthesized from Pd and Pt precursors. The Pd and Pt catalyst particles are then mixed with an alumina slurry, which is subsequently sprayed onto the substrate 17, for example, utilizing thermal spraying.

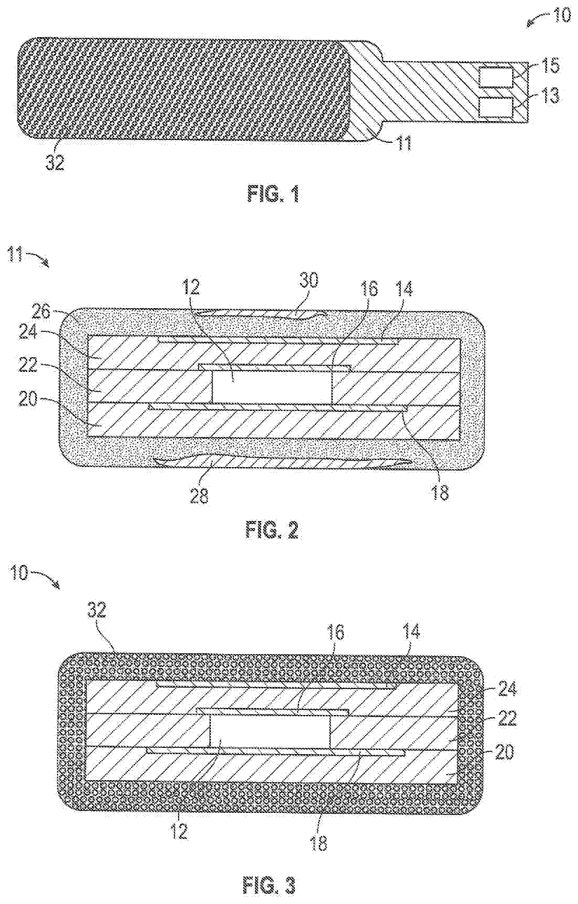

The sensor 10 formed by the aforementioned process is in contrast to a sensor 11 (FIG. 2) in which an alumina slurry is initially applied to the substrate to form an alumina coating 26. The alumina coating 26 is then dipped into a Pd and Pt catalyst precursor solution to impregnate the porous alumina coating 26, and the coating 26 and catalyst solution are dried by activating a heater element 18. The dipping and drying process, however, creates a non-uniform distribution of the Pd and Pt catalyst particles. Specifically, an accumulation or agglomeration of the Pd and Pt catalyst particles occur, as indicated by the regions 28 and 30 because of capillary diffusion of the catalyst precursor solution during the drying process. Note that the agglomeration of the Pd and Pt catalyst particles in the regions 28 and 30 leads to sintering of the particles during the use of the sensor 11, resulting in reduced catalytic activity and reduced durability of the sensor 11.

Accordingly, the process associated with the sensor 10 shown in FIGS. 1 and 3, significantly reduces or eliminates the sintering effect, and, hence, promotes improved performance and durability of the sensor 10. The process for fabricating the sensor 10 also reduces warranty costs associated with returned sensors and also reduces costs by eliminating the drying process associated with the sensor 11.

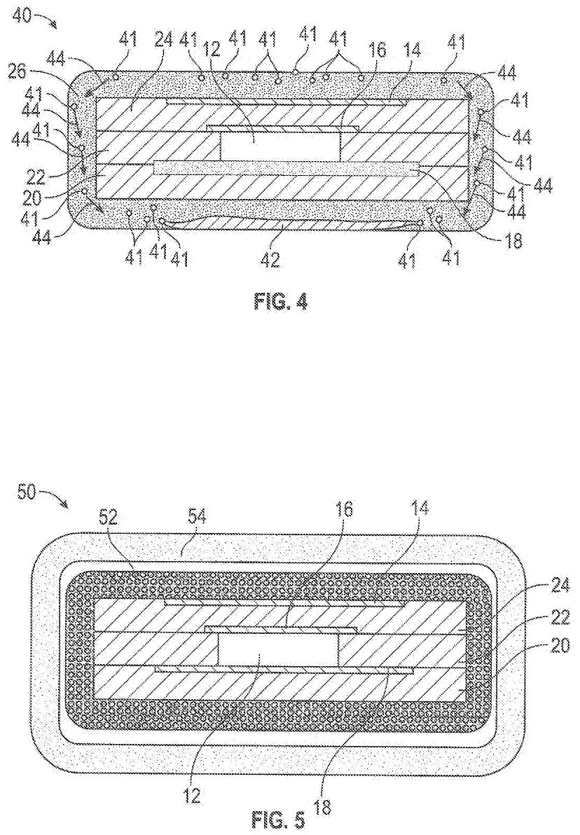

In another arrangement, in accordance with the principles of the present invention, the sensor 10 is formed by an alternative process by first thermal spraying an alumina slurry onto the substrate 17 to form an alumina coating and then dipping the coating in a catalyst solution of nitrate based catalyst precursors Pd(NO₃)₂ and Pt(NO₃)₄. The nitrate based catalyst precursors dry and decompose at lower temperatures than a chloride based precursor solution typically associated with the fabrication of the sensor 11 shown in FIG. 2. Specifically, Pd(NO₃)₂ decomposes to Pd and NO₃ at a temperature of about 100° C., and Pt(NO₃)₄ decomposes to Pt and NO₃ at a temperature of about 427° C. In the chloride based solution (PdCl₂ and PtCl₂) employed for the fabrication of the sensor 11, the PdCl₂ catalyst precursor decomposes to Pd and CI at a temperature of about 679° C. and the PtCl₂ catalyst precursor decomposes to Pt and CI at a temperature of about 581° C. As shown in FIG. 4, these elevated temperatures that occur during the drying process for the fabrication of the sensor 11 by activating the heater element 18 provide the driving force for the catalyst solution's migration of particles 41 towards the heater element 18, as indicated by the arrows 44, such that agglomeration of the catalysts form in the region 28. Whereas, the lower temperatures associated with the alternative fabrication of the sensor 10 during the drying process minimizes the migration of the catalyst particles.

Referring now to FIG. 5, there is another arrangement 50 that is utilized to form the coating 32 with a uniform distribution of Pd and Pt catalyst particles. Specifically, the alumina slurry it thermally sprayed onto the substrate 17 to form an alumina coating which is then dipped into a solution of Pd and Pt catalyst precursors. But rather than employing the heater element 18, as associated with FIG. 4, an external heater 54 is utilized. As such, the uniform heating prevents the migration of Pd and Pt catalyst particles during the drying process of the sensor.

In various arrangements, Pd and Pt precursors are first processed to obtain Pd/Pt particles which are then mixed with the alumina slurry. In certain arrangements, the alumina slurry is mixed with Pd/Pt precursors. The slurry is then heated to form Pt/Pd particles in the alumina slurry.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An oxygen sensor for a motor vehicle, the sensor comprising:
a substrate including:
a first ceramic layer including a Nernst cell;
a second ceramic layer including a reference cell;
a third ceramic layer, the second ceramic layer positioned between the first ceramic layer and the third ceramic layer; and
a heater element positioned between the second ceramic layer and the third ceramic layer; and
an alumina coating covering the substrate, palladium (Pd) and platinum (Pt) catalyst particles being uniformly distributed in the alumina coating.

2. The sensor of claim 1, wherein the Nernst cell is defined by a first electrode and a second electrode spaced apart from the first electrode.

3. The sensor of claim 2, wherein the first electrode and the second electrode are made of Pt.

4. The sensor of claim 1, wherein the reference cell is a hollow region in the second ceramic layer to provide a channel for gas flow.

5. The sensor of claim 1, wherein a catalyst particles or precursor solution is premixed in an alumina slurry that is sprayed onto the substrate to form the alumina coating.

6. The sensor of claim 5, wherein the catalyst precursor solution is nitrate based including Pd(NO₃)₂ and Pt(NO₃)₄ or chloride based including PdCl₂ and PtCl₂.

7. The sensor of claim 1, wherein an alumina slurry is sprayed onto the substrate to form the alumina coating which is subsequently dipped into a catalyst precursor solution.

8. The sensor of claim 7, wherein the catalyst precursor solution is nitrate based including Pd(NO₃)₂ and Pt(NO₃)₄ or chloride based including PdCl₂ and PtCl₂.

9. The sensor of claim 8, wherein an external heater is activated to dry the alumina slurry with the Pd/Pt precursors.

10. The sensor of claim 1, wherein the alumina coating fully covers the substrate.

11. A method of forming an oxygen sensor implemented in a motor vehicle, the method comprising:
applying an alumina slurry covering a substrate, palladium (Pd) and platinum (Pt) catalyst precursors or particles being uniformly distributed in the alumina slurry,
the substrate including:
a first ceramic layer with a Nernst cell;
a second ceramic layer with a reference cell;
a third ceramic layer, the second ceramic layer positioned between the first ceramic layer and the third ceramic layer; and
a heater element positioned between the second ceramic layer and the third ceramic layer;
heating the alumina slurry to form an alumina coating, Pd and Pt catalyst being uniformly distributed in the alumina coating.

12. The method of claim 11, wherein the Nernst cell is defined by a first electrode and a second electrode spaced apart from the first electrode.

13. The method of claim 11, wherein the reference cell is a hollow region in the second ceramic layer to provide a channel for gas flow.

14. The method of claim 11, wherein a catalyst particles or precursor solution is premixed in the alumina slurry that is sprayed onto the substrate to form the alumina coating.

15. The method of claim 14, wherein the catalyst precursor solution is nitrate based including Pd(NO₃)₂ and Pt(NO₃)₄ or chloride based including PdCl₂ and PtCl₂.

16. The method of claim 11, wherein the alumina slurry is sprayed onto the substrate to form the alumina coating which is subsequently dipped into a catalyst precursor solution.

17. The method of claim 16, wherein the catalyst precursor solution is nitrate based including Pd(NO₃)₂ and Pt(NO₃)₄ or chloride based including PdCl₂ and PtCl₂.

18. The method of claim 11, wherein heating includes heating with an external heater that is activated to dry the alumina slurry with the Pd/Pt particles or precursor solution.

19. The method of claim 11, wherein the alumina coating fully covers the substrate.

20. An oxygen sensor for a motor vehicle, the sensor comprising:
a substrate including:
a first ceramic layer including a Nernst cell, the Nernst cell being defined by a first electrode and a second electrode spaced apart from the first electrode, the first electrode and the second electrode being made from Pt;
a second ceramic layer including a reference cell, the reference cell being a hollow region in the second ceramic layer to provide a channel for gas flow;
a third ceramic layer, the second ceramic layer positioned between the first ceramic layer and the third ceramic layer; and
a heater element positioned between the second ceramic layer and the third ceramic layer; and
an alumina coating covering the substrate, palladium (Pd) and platinum (Pt) catalyst particles being uniformly distributed in the alumina coating.
